(19) United States
(12) Patent Application Publication
(10) Pub. No.: US 2005/0172234 A1
(43) Pub. Date: Aug. 4, 2005

(54) Video display system

(76) Inventor: Jonathan E. Chuchla, Chicago, IL (US)

Correspondence Address: VEDDER PRICE KAUFMAN & KAMMHOLZ, 222 N. LASALLE STREET, CHICAGO, IL, 60601, US

(21) Appl. No.: 10/770,911

(22) Filed: Feb. 3, 2004

(51) Int. Cl. G06F 17/00; G06F 9/00

(52) U.S. Cl. 715/735; 715/765

(57) ABSTRACT

A fixed-pixel array display system and video processor merge multiple video streams, each from a separate computer or non-VESA compliant video source, into a single VESA-compliant video stream. The separate video streams are re-formatted by the video processor to fit within its own display area. The display areas are separately determined by the processor. Arrays along the edges of the fixed-pixel array display device detect a tactile contact with the display screen. The coordinates of a tactile contact are read by the video processor and correlated to a sector of the display device where a video image is displayed. The location of the tactile contact is sent to the video source as an input to its graphical user interface. Separate computers or other video sources with graphical user interfaces can be controlled from the single display device using the touch sensitive input screen.

### FIELD OF THE INVENTION

This invention relates to display systems. In particular, this invention relates to a system and method for displaying different-format video images from different video sources on a single display device, but which also provides a capability to direct control signals to each of the video sources.

### BACKGROUND OF THE INVENTION

Prior art liquid crystal display (LCD) projectors and digital light projectors (DLPs) enable video from a single computer to be projected on a wall or screen. While these devices are well suited to project video from a single computer, they are not able to project onto a single display surface, video images created by two, three or more computers. They are also unable to provide any sort of input capability to the graphical user interfaces (GUIs) commonly used on personal computers. Prior art LCD and DLPs require a user to input mouse clicks by the graphical user interface provided on the computer the output of which is projected by the LCD or DLP device. A video display system that can project video outputs from several computers and in addition, provide an input interface to each computer would be a an improvement over the prior art.

### SUMMARY OF THE INVENTION

There is provided a video display system that projects or displays video images from several different sources in separate display areas of the device. Video images from each of the separate sources are “sized” by a video processor so that each video image is displayed within substantially-equivalent-sized display areas.

The video processor accepts both VESA-compliant signals and non-VESA-compliant signals and formats video signals into a VESA-compliant video signal. A touch-sensitive display screen on which the VESA-compliant signal is displayed, detects a tactile contact with the screen. The location of a tactile contact on the screen is correlated with the computer or other video source that generated an image “under” where the contact occurred. When the location where a tactile contact coincides with a projected icon where the tactile contact was detected, the video processor identifies the tactile contact as an input to a GUI of the processor generating the video image “below” the point where a tactile contact occurred on the display device. The display device thus performs the function of both an output display device and an input device for multiple computers (or other video sources) at the same time.

### BRIEF DESCRIPTION OF THE DRAWINGS

FIG. 1 shows an embodiment of a video display system.

FIG. 2 shows a block diagram of a method for handling tactile control signals between a tactile contact detection device and the processor and multiple computers.

FIGS. 3A-3D show examples of display modes.

### DETAILED DESCRIPTION OF THE PREFERRED EMBODIMENTS

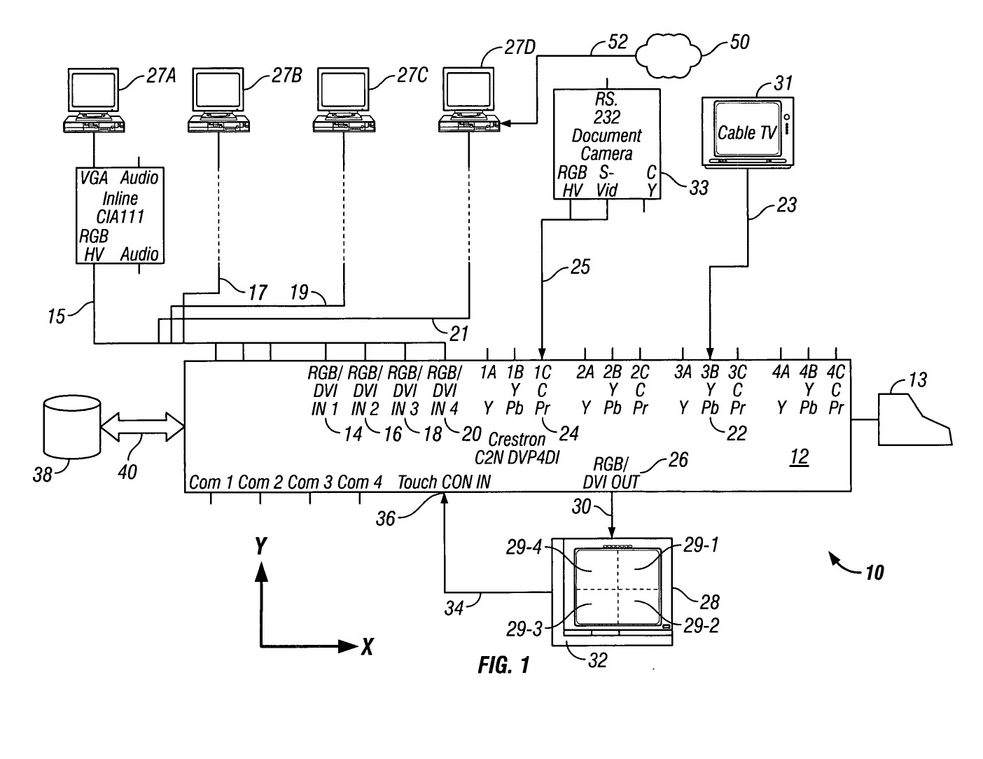

FIG. 1 is a block diagram of a video display system 10. The system 10 is comprised of a video processor 12, which in the preferred embodiment is a Crestron Model c2nDVP4di video processor. The video processor 12 is controllable by way of a terminal 13, through which the processor 12 can be programmed.

The video processor 12 has several separate video input ports 14, 16, 18, 20, 22 and 24. Each of the video input ports is capable of receiving video signals of different formats. At least some of the input ports 14-20 receive VESA-compliant video signals. Other video input ports 22 and 24 receive other video formats, including NTSC NTS video-format signals.

The video processor 12 is coupled to a memory storage device 38 via an address and control bus 40. The processor 12 executes program instructions stored in the memory 38. The memory storage device 38 can be embodied as a hard disk drive, floppy disk drive, CD ROM, ROM or even RAM devices, all of which are equivalent storage devices. As with all stored program processors, the video processor 12 reads and executes instruction stored in the memory 38. In other words, the stored program instructions cause the processor to perform operations described more fully hereinafter.

As shown in FIG. 1, video signals output from four separate computers 27A-27D are coupled to video input terminals 14-20 of the video processor 12. The video signals output from the computers are VESA-compliant signals and are part of the graphical user interface or “GUI” of the computers. As is known, video images of a GUI include icons, which when they are selected and actuated by a pointing device such as a mouse, cause the computer that displays them to perform an operation.

The video processor 12 is also coupled to and receives non-VESA compliant NTSC video signals, such as broadcast television or cable television video 31. In addition to television video 31, a document camera or other non-VESA compliant video 33 is coupled to an input to the video processor 12.

The video processor 12 is programmed via instructions entered through the terminal 13 to cause the processor to perform operations on the video signals received at the input ports 14-20 and 22, 24. In particular, the video processor 12 receives the NTSC video format signals at the input ports 22 and 24 and reformats non-VESA compliant signals to VESA compliant signals using techniques that are known in the art.

VESA-compliant video signals from the computers 27A-27D and video signals from non-VESA compliant sources are processed by the video processor 12 so that video images from the computers 27A-27D and the non-VESA compliant video sources 31 and 33 can be mixed into a single video output signal 30 that is displayed on a fixed pixel array display device 28. Each video signal from each source is processed such that each video image from each video source is displayed within its own area on the fixed pixel array display device 28. In a preferred embodiment, each video image is displayed in an area that is substantially equal to the areas in which other video images are displayed. Stated alternatively, the video processor 12 reformats video signals from each video source so that the video images from each source is scaled to fit within a window area of the fixed pixel array display device 28 that is substantially equal to the areas in which other images from other sources is displayed.

In the preferred embodiment, the fixed pixel array display device is a rear projection Smart Technologies Smart Board™, which has a VESA-compliant video input port into which video signals from the processor 12 are sent. Video signals from the processor 12 generate multiple images on the display device 28, each of which is from a separate video source.

In one embodiment, the display area of the display device 28 is segmented by the video processor 12 into four separate and substantially equal areas 29-1, 29-2, 29-3 and 29-4. As set forth above, the video processor 12 adjusts the size of video images from video sources 27A-27D, 31 and 33 so that the space occupied by each displayed image from each source is substantially the same and will fit within a window. In the embodiment of the display area shown in FIG. 1, the display area is divided into four separate and equal-sized areas identified by reference numerals 29-1—29-4. Video that appears in one of the areas is reformatted by the video processor to fit within its corresponding window.

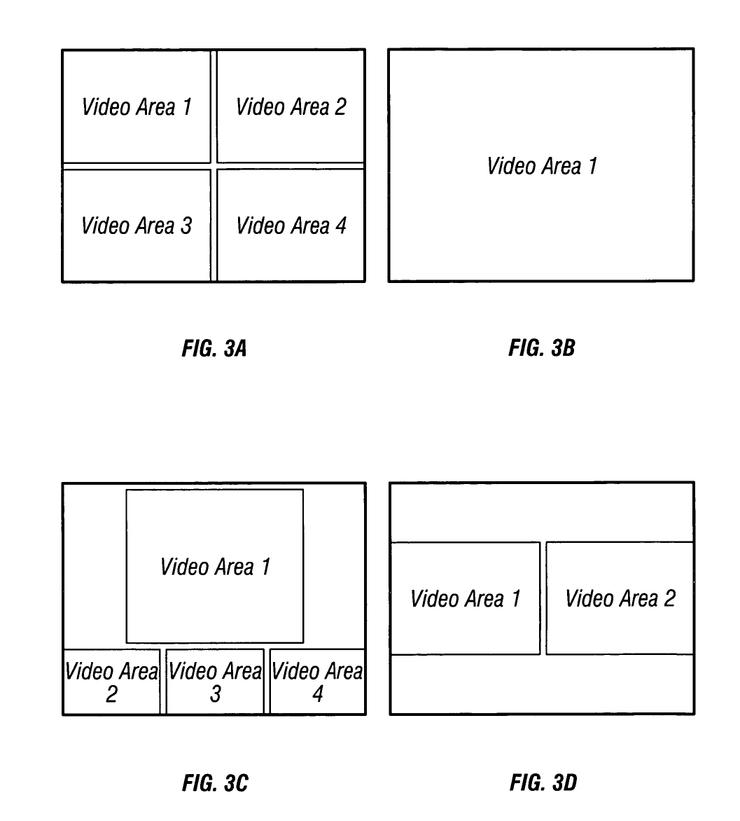

FIGS. 3A-3D show examples of some display modes. In FIG. 3A, the display screen is partitioned into four, substantially equal-sized display areas. Four different video images can be displayed on the display screen with each of the four areas displaying a separate video source. Optical tactile sensors detect tactile contact anywhere on the display device and locate the tactile contact on the board. The location of the tactile contact on the display surface is sent to the processor that generated the video image, which then processes the tactile contact as an input to its own graphical user interface.

FIG. 3B shows the entire display device used to display a single video source. FIG. 3C shows an alternate division of the display device into four separate windows whereas FIG. 3D shows how the display surface could be divided into two separate windows.

In each of the embodiments shown in FIGS. 3A-3D, tactile contact on the display device is returned to the video source that produced the image where the tactile contact occurred. Where the tactile contact actuates the graphical user interface of the video source is determined by the video source that generated an image where the tactile contact occurred.

In order to ensure that a video image from a video source will fit within a predetermined display area, the video processor compresses a video image size, typically by deleting one or more pixels in both the vertical and horizontal directions. The processor 12 expands a video image size by interpolating and adding pixels in either or both the vertical or horizontal directions. Other techniques for expanding and contracting the size of a displayed video image are known to those of skill in the art and not discussed further herein for purposes of brevity.

In addition to sizing a video image from a video source, the video processor 12 resizes display areas. Re-sizing display areas enables the number of display areas to be increased or decreased under software control.

Scaling is handled by the Crestron video processor. The location of a tactile contact on the display device is determined by triangulating the detected instance of a tactile contact from at least two corners of the display device. Triangulation of a tactile contact is a matter of geometric calculations. A publication of SMART Technologies, Inc. available on line at www.smarttech.com/dvit/ describes locating a point on the screen. In the preferred embodiment, the fixed pixel array display device 28 includes a system of four video cameras in the four corners of the video display surface. When a finger or other object contacts or approaches the surface of the display device 28, the finger or object near or contacting the display device surface is a dark area in the video image of each of the four cameras. The angle of view from each camera can detect a tactile contact along a diagonal line perpendicular to the camera's own direction of view. Software which manipulates the four camera's views, provide a mechanism for precisely locating where a tactile contact with the surface of the display device 28 takes place. When a tactile contact is visible from the four angles of view, it is possible to precisely locate where an object is present on the display screen.

The term “tactile contact” should be construed to mean either an actual touching of the display surface by a finger or other object or a near-contact by which both of the aforementioned orthogonal light beams are interrupted. When a finger or object makes tactile contact with the display surface, the video processor 12 detects the tactile contact and correlates the location of the tactile contact on the display device 28 with a video image displayed in the area 29-1—29-4 where the tactile contact was detected by the processor 28. If the tactile contact coincides with the location of a displayed icon of the GUI of the processor, the processor treats such a tactile contact as a GUI command to perform a corresponding action. If the tactile contact does not correspond with a processor's GUI item, the processor's software determines the video area that the contact occurred in and routes a scaled modification of the coordinate location of the contact to the appropriate device from which the video in the appropriate area originated.

In order to correlate a tactile contact with the display screen surface with a displayed image or icon from a video source, the video processor 12 converts the tactile contact with the screen surface into an input signal for a computer program running on a computer that generated a video image in an area 29-1—29-4 of the fixed pixel array display device 28. Stated alternatively, when the video processor 12 is displaying video images output from several computers, a tactile contact on the display device 28 is converted by the video processor 12 into a mouse click. By knowing where a tactile contact occurred on the display device, the tactile contact can be mapped to a mouse click or other input signal to the computer or other video signal source that generated the image underneath where the tactile contact occurred.

The logical video ports 14, 16, 18, 20 are bi-directional ports. These ports are actually two separate ports for each logical connection. One part of each port 14, 16, 18 and 20 is a VESA compliant video input port for the video from the source computer, the other part of each port 14, 16, 18 and 20 is a bi-directional RS-232 serial control port. Video signals are received from the video sources on the VESA compliant video port and serial control signals are also sent to and from the video originating sources via the corresponding RS-232 serial ports. Signals from the optical display array 28 generated by the method described in paragraph 20, are sent to the video processor 12 as a serial data stream 34, which is received at a control input 36 on the video processor 12. Computer program instructions stored within a memory 38 strip off certain information, recognized the location on the display device 28 where a tactile input was made, correlate the tactile input with a displayed image from one or more of the video sources and in response, sent a corresponding input command to the device as if the input were received by the device from either its mouse or key board. Stated alternatively, tactile contacts with the display device 28 are located by the processor 12 and mapped to the video source as an input to its graphical user interface (GUI).

The fixed-pixel array display device 28 is preferably embodied as a liquid crystal display device. Alternate embodiments could include certainly DLP projectors, subject to the limitation that the display device 28 include a mechanism by which a tactile input can be detected and processed to actuate an icon displayed by the display device 28, even if the display device 28 is displaying video images from multiple sources. While the preferred embodiment fixed pixel array display device 28 provided a tactile contact input capability by way of the aforementioned optical sensors and optical sources, alternate embodiments would include using a touch-sensitive membrane overlaying the display device screen (not shown). Touch-sensitive membranes also generate x-y coordinate signals that identify where a contact with the membrane is made. However, such membranes are susceptible to damage and also dim or reduce the brightness intensity output by the back lighting of an LCD device or DLP projector.

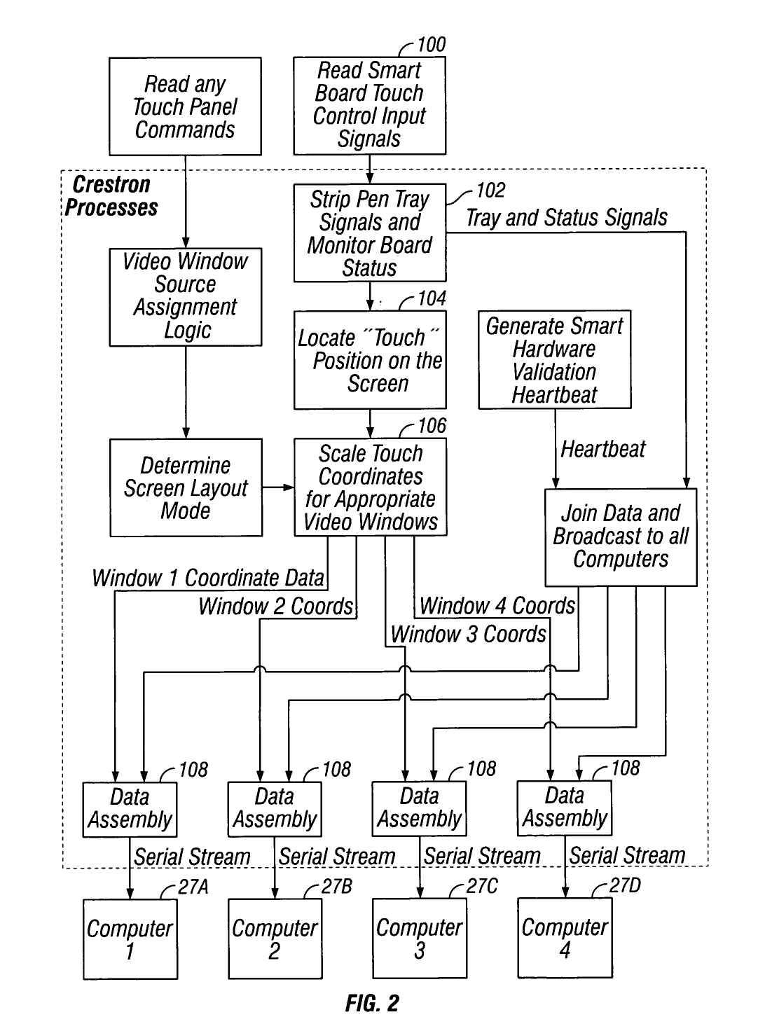

FIG. 2 is a block diagram of a method of detecting tactile contact as input to a graphical user interface of a device that generated a video image on the display device 28 where a tactile input was detected. In particular, the method disclosed in FIG. 2 is directed to steps required to display multiple images on a Smart Technologies Smart Board and to read tactile input off the Smart Board and correlate it with a video image generated by one of several possible video sources. Those of ordinary skill will recognize that the method disclosed in FIG. 2 can be extended to other input/output devices.

In step 100, the video processor 12 reads the control input port 36 of the processor 12 for control signals generated by and output from the display device 28, which also includes a tactile contact sensor as described above.

Smart board Pen tray signals monitored by the processor's software:

Pen tray Commands From Smart Board to processor

| | | | | | | |
|---|---|---|---|---|---|---|
| No Tool | AA | A4 | 06 | 00 | 00 | 00 |
| Eraser | AB | A4 | 06 | 00 | 01 | 00 |
| Black Pen | AC | A4 | 06 | 00 | 02 | 00 |
| Blue Pen | AE | A4 | 06 | 00 | 04 | 00 |
| Red Pen | B2 | A4 | 06 | 00 | 08 | 00 |
| Green Pen | BA | A4 | 06 | 00 | 10 | 00 |

LED commands from processor to Smart Board

| | | | | | | |
|---|---|---|---|---|---|---|
| No Tool | 91 | 91 | 00 | 00 | 00 | 00 |
| Eraser | 92 | 91 | 00 | 00 | 01 | 00 |
| Black Pen | 93 | 91 | 00 | 00 | 02 | 00 |
| Blue Pen | 95 | 91 | 00 | 00 | 04 | 00 |
| Red Pen | 99 | 91 | 00 | 00 | 08 | 00 |
| Green Pen | A1 | 91 | 00 | 00 | 10 | 00 |

When the processor receives a pen tray status command from the Smart Board, it is then broadcast to all of the connected computers, regardless of location of tactile contact activity. The processor also issues a LED command back to the Smart Board to illuminate the appropriate feedback indicator located on the pen tray.

The Processor maintains in RAM the current pen status obtained by regular polling of the Smart Board. Upon a “Status Request” command from each computer, the processor generates and communicates the current status of the Smart Board.

The Smart Board driver software requires a “heartbeat signal” to be intermittently sent to and from the Smart Board to authenticate that a valid device is connected. The heartbeat signal is emulated by the processor and communicated independently for each connected computer, and the Smart Board itself. The processor's software behaves as the Smart Board when communicating with each computer, and as the computer [software] when communicating with the Smart Board.

A user can put the display system into one of several “Display Modes”. These modes define the size and position of the video areas within the whole video area of the system. (FIG. 3). The processor assigns an address to each video area (hereafter “window”). Along with the address of each window, the information relating to the size and location is stored. The size is stored as a percentage of the whole video area, and the position is stored as an offset to the origin of the whole video area. When a tactile contact is made with the display surface, the processor determines if it is within the boundaries of a video window. If it is within a video window, the coordinate data is multiplied by the window size data, and the offset data is added to the coordinate data and this modified value is routed to the appropriate computer from which the video is displayed in said window.

In the preferred embodiment, the SMART BOARD includes a pen tray and pen tray sensors to indicate whether or not writing pens for the SMART BOARD are present in their holding tray. The data stream from the Smart Board is processed in step 102 to strip away pen tray signals to be monitored by the processor and broadcast to all of the connected video sources/computers simultaneously. The pen status is sent to all of the computers simultaneously to facilitate fast, seamless switching from controlling one computer to the next. Without this feature, If the user is working in one video area (e.g., the area for computer 1), and then switches to another area (e.g., the area for computer 2), The second computer would not be aware of any pen status changes since the time when it was last the active window.

Upon the detection of a board status change in step 102, the board will interrupt the serial stream with a status change signal. However, if there is active data in the stream, the status signal may be missed. For this reason, the board is also regularly polled by the processor as to it's status. The data stream or signal 34 output from the display device 28 includes a status word, the contents of which is read followed by extraction of the x-y coordinates along the horizontal and vertical axes to locate where a person touched the screen surface. Inasmuch as the Smart Board uses an visual sensor methodology to detect tactile contact with the display surface, an actual contact is not required. Rather, all that is required to create a tactile contact is an electronically visible contact within the field of view of multiple camera sensors in both the x and y directions.

Once the location of a tactile contact with the screen surface is determined in step 104, the section of the display device 28 in which the tactile contact was made can be identified. For instance, a tactile contact that occurs within a quadrant identified by reference 29-1 can be correlated with a video image generated by the computer or other video source the video output signal of which is displayed in that first quadrant.

In step 106, the location of a tactile contact is scaled to place the contact with the screen at a relative location in a particular quadrant where it occurred. In particular, the location of a tactile contact with the screen is placed or located within the display area by scaling or dividing the x and y coordinates by the percentage of the entire display area that the display sector is.

By locating the tactile contact at a particular location within a particular area, the video processor is able to send precise coordinates of where a tactile contact occurred and send this information to the computer 27A-27D generating the image in the particular quadrant where the tactile contact occurred. In step 108, a data stream that identifies where in the particular window the contact occurred is sent to the particular computer. Operating system software running on each of the computers is able to receive the contact information as if it were a mouse click that includes a location on the screen where the icon pointer is located.

The processor 12 is connected via an Ethernet port to the Internet. This connection allows the processor 12 to be connected to a remote computer for system 10 monitoring and administration. A user connected by means of a remote computer (not shown) can view the system's status, as well as make certain inputs to the processor 12. Remotely accessible status functions include which one of several video modes that the system is currently operating in, Which video source is routed to each display area, the power status of the system, and the power and error status of the video projector device are also tracked and controlled remotely via the Internet. Remotely accessible input functions include the ability to cycle the power status of the system and/or video projection device, and change the video signal routing.

The processor is connected via RS-232 serial port to an external audio switching device. Each video device has a corresponding audio signal. Recognizing that while the human eye can move between video areas to perceive different video information in different areas, it cannot sort between different simultaneous audio information. It becomes necessary to allow the user to determine which audio source is desired as relevant at any given time. On screen GUI items of the processor allow the user to determine which audio source to listen to. These GUI commands cause the processor to execute instructions to cause the external audio switching device to make the appropriate audio signal be heard in the room.

The processor is connected via RS-232 to an audio mixing device. The audio signal from a presenter's microphone is mixed with the audio corresponding with the program audio from the aforementioned desired audio source. The processor controls the attenuation which directly controls the perceived volume of the microphone and/or program audio to levels determined by the user's input to the processor's control input device.

The processor is connected via Cresnet (Crestron proprietary 4 wire serial control bus) to a touch enabled GUI device (afterwards, “touchpanel”), separate from the display device, for the presenter to control the functions of the system by way of the processor. This allows the presenter to switch display modes (typical display modes illustrated in FIG. 3), to route video sources to desired video window areas on the display device, to control transport functions of certain video sources, to control volume, and to control the power state of the system.

The system is connected via infrared light to a DVD/VCR combination player. The presenter can control the transport functions of the recorded DVD or VCR media from the touchpanel. User input to the GUI elements on the touchpanel causes the processor to generate infrared signals to cause the DVD/VCR player to perform the desired action. Transport functions include but are not limited to “Play”, “Pause”, “Stop”, “Rewind”, “Forward”.

By way of the foregoing, the video processor 12 reformats video signals from a collection of disparate sources, displays the video images in defined areas of the display device and senses when a tactile contact in a particular window has been made. The tactile contact is coordinated or identified as an input to an icon or image displayed by a video source by sending the contact occurrence to the particular computer or other video source which can then translate the contact as if the contact occurred on the actual computer.

By way of the foregoing, it is possible to display several video images from several disparate video sources on a single display device. Groups of computers can have their outputs presented in meeting rooms and other large assembly areas with control of each of the computer being handled by the single video display device.

1. A video display system comprised of:
a video processor having at least a first computer video input port and a second, NTSC video input port and a video signal output port, capable of being operatively coupled to a fixed-pixel array video display device; and
a memory storage device, operatively coupled to the video processor and storing program instructions which, when executed cause the video processor to format video input signals at both ports, into a single VESA compliant video signal that is sent to a fixed pixel video display device where upon video input signals are scaled to fit to video window areas within the fixed pixel array display device.

2. The video display system of claim 1 wherein said video processor includes:
a control input that is capable of being coupled to a fixed pixel array display device that provides a signal to the video processor that indicates where a tactile contact with the display device was made; and
where said memory includes additional instructions which when executed cause said processor to read a signal at said control input and correlate the location of a contact with said fixed-pixel array display device with an image being projected on said device.

3. The video display system of claim 1 wherein said video processor further includes:
a control input that is capable of being coupled to a fixed pixel array display device;
and wherein said video display system is further comprised of:
a display device having an optical sensor operatively coupled to the control input and which generates a signal for the video processor that indicates where a contact or near contact with the display device surface was made; and
where said memory includes additional instructions which when executed cause said video processor to read a signal at said control input and correlate the location of a contact or near contact with said fixed-pixel array display device surface with an image being projected on said device.

4. The video display system of claim 1 wherein the memory storage device stores program instructions which when executed cause the video processor to display a video image from a video source in a corresponding window on the display device.

5. The video display system of claim 1 wherein the memory storage device stores program instructions, which when executed cause the video processor to alter a video image from a video source by adding or deleting vertical pixels and adding or deleting horizontal pixels.

6. A video display system comprised of:
a VESA-compliant, fixed-pixel array display device said display device capable of displaying multiple video images in separate display areas of the display device, each video image displayed on the display device being generated from a corresponding video signal from a corresponding video source;
a video processor, the video processor having a first video input port that is capable of receiving a first format video signal and, a second video input port that is capable of receiving a second format video signal, at least one of said first and second video signal formats capable of being a non-VESA compliant format, said video processor having a VESA-compliant video signal output port operatively coupled to the video display device from which a VESA-compliant video output signal is output; and
memory, operatively coupled to the video processor and storing program instructions which, when executed cause the video processor to process at least one of:
the first video signal and the second video signal received at the second video input, into a single format, such that a video image produced on the display device by the first video signal and a video image produced on the display device by the second video signal, are of substantially the same size on, and in different sections of, the display device.

7. The video display system of claim 6 wherein said fixed-pixel array display device includes:
a touch-sensitive membrane by which tactile contact with the fixed-pixel array display device is detected and which generates a touch-location signal that identifies where a contact with the touch-sensitive membrane was made; and
where said processor includes a control input port coupled to said fixed-pixel array display device and which receives the touch-location signal; and
where said memory includes additional instructions which when executed cause said processor to read a signal at said control input and correlate the location of a contact with said membrane with an image being projected on said device.

8. The video display system of claim 6 wherein said fixed-pixel array display device includes:
an optical sensor by which tactile contact with the fixed-pixel array display device surface can be detected and which generates a touch-location signal that identifies where a contact with the surface of the display device was made; and
where said processor includes a control input port coupled to said fixed-pixel array display device and which receives the touch-location signal; and
where said memory includes additional instructions which when executed cause said processor to read a signal at said control input and correlate the location of a contact with the surface of the display device with an image being projected on the display device.

9. The video display system of claim 8 wherein the processor has a second control output that is capable of being coupled to a computer generating video output that is to be displayed on said display device and wherein the memory stores additional instructions, which when executed, cause the processor to send a command to the computer generating video informing the computer that a tactile contact with the surface of the display device was equivalent to a mouse pointer selection for the computer.

10. The video display system of claim 6 wherein the memory stores program instructions which when executed cause the video processor to format video signals to alter the size of an image generated on a display device by at least one of the first and second video signals.

11. The video display system of claim 6 wherein the memory stores program instructions, which when executed cause the video processor to process at least one of the first video signal and the second video signal to alter at least one of: the vertical pixel count, and the horizontal pixel count, of a video image generated on a display device by at least one of: the first video signal and the second video signal.

12. A video display system comprised of:
an input/output (I/O) device having a fixed-pixel array display device that is VESA compliant and capable of displaying one or more video images, each of the video images being generated by a corresponding video signal, each video image being displayed in its own area of the fixed-pixel array display device said I/O device also having an optical touch-sensor by which the location of a contact with the display device is determinable;
a processor having a first video input port that is capable of receiving a first video signal from a first video source, a second video input port that is capable of receiving a second video signal from a second video source, and a tactile sense input coupled to the input/output device and receiving signals from which the location of a tactile contact with the input/output device can be determined, said processor having a video signal output port operatively coupled to the fixed pixel array video display device; and
memory, operatively coupled to the processor and storing program instructions which, when executed cause the processor to process at least one of: the first video signal and the second video signal into a single VESA-compliant format, such that a video image produced on the fixed pixel array display device by the first video signal and a video image produced on the fixed pixel array display device by the second video signal, are in different sections of the display device, the program instructions further causing the processor to read signals indicative of a tactile contact with the display device and to display on the I/O device, an indication that the tactile contact was detected.

13. The video display system of claim 12 wherein the memory stores program instructions which when executed cause the processor to format the first and second video signals to alter the size of an image generated on a display device by at least one of the first and second video signals so that the displayed size of images produced by each signal is substantially the same.

14. The video display system of claim 12 wherein the memory stores program instructions, which when executed cause the processor to process at least one of the first video signal and the second video signal, so as to alter at least one of: the vertical pixel count, and the horizontal pixel count, of a video image generated on a display device by at least one of: the first video signal and the second video signal.

15. A video display system comprised of:
a display device capable of displaying one or more video images, each generated by a corresponding video signal, each video image being displayed in its own area of the display device, said display device also having an optical tactile contact sensor by which the location of a tactile contact with the touch-sensitive input screen is determinable;
a Crestron video processor operatively coupled to the display device, the video processor capable of receiving a first video signal from a first non-VESA compliant source, a second video input port that is capable of receiving a second, VESA-compliant video signal from a second video source, and a tactile sense input coupled to the display device and receiving signals indicative of the location of a tactile contact with the display device, said processor having a video signal output port operatively coupled to the display device; and
memory, operatively coupled to the Crestron video processor and storing program instructions which, when executed cause the processor to process at least one of: the first video signal and the second video signal into a single VESA-compliant format, such that a video image produced on the display device by the first video signal and a video image produced on the display device by the second video signal, are of substantially the same size on, and in different sections of the display device, the program instructions further causing the processor to read signals indicative of tactile contact with the display device and to display on the display device, an indication of the tactile contact to electronically simulate the action of drawing on the screen with a marker or to manipulate the functions of the attached computers.

16. The video display system of claim 15 wherein the memory stores program instructions which when executed cause the Crestron video processor to format the first and second video signals to alter the size of an image generated on the display device by at least one of the first and second video signals so that the displayed size of images produced by each signal may be substantially the same or significantly different.

17. The video display system of claim 15 wherein the memory stores program instructions, which when executed cause the Crestron video processor to process at least one of the first video signal and the second video signal, so as to alter at least one of: the vertical pixel count, and the horizontal pixel count, of a video image generated on the display device by at least one of: the first video signal and the second video signal.

18. A method of displaying multiple video images on a single display device comprise of the steps of:
receiving a plurality of video signals at a video processor, each of the video signals being capable of being processed to generate an image on a display device such that a first one of the video signals will generate an image of a first size on a display device and a second one of the video signals will generate an image of a second size on a display device; and
processing at least one of the video signals after its receipt so that when the first and second video signals are processed, they each generate images of the same size on a display device.

19. The method of claim 18 wherein the step of processing at least one of the video signals includes the steps of: changing the number of pixels in at least one of the vertical and horizontal directions of at least one of the video signals so that images generated on a display device are substantially the same size.

20. The method of claim 18 wherein the step of processing at least one of the video signals includes the step of processing video signals in a Crestron video processor.
